(19) United States
(12) Patent Application Publication
(10) Pub. No.: US 2008/0048030 A1
(43) Pub. Date: Feb. 28, 2008

(54) Merchandise tagging to prevent theft and fraud

(76) Inventor: Ralph Garner, Chandler, AZ (US)

Correspondence Address: ETHERTON LAW GROUP, LLC, 5555 E. VAN BUREN STREET, SUITE 100, PHOENIX, AZ, 85008, US

(21) Appl. No.: 11/974,454

(22) Filed: Oct. 11, 2007

Related U.S. Application Data
(63) Continuation-in-part of application No. 11/135,262, filed on May 23, 2005, now Pat. No. 7,311,253.

(51) Int. Cl. G06K 15/00; G06Q 30/00

(52) U.S. Cl. 235/383; 235/385

(57) ABSTRACT

A method for preventing retail return fraud is implemented by attaching a security tag to a customer's purchased garment at checkout or before the customer leaves the store. The security tag displays text stating that the merchandise cannot be returned to the retail store if the security tag is removed or if the security tag or garment is washed or dry-cleaned. The security tag is attached by a tamper-proof attachment mechanism, such as a loop tie. The security tag is large and ostentatious, and attached in a location on the garment that will discourage the customer from wearing it without removing the security tag. Immediately before attachment, the security tag is stamped by a stamping machine with a code designating the retail store and time and date of purchase, and may optionally be stamped with additional identifying information such as the sale price. If the customer attempts to return the item to the seller and the security device has been altered, the seller refuses to accept return.

### CROSS-REFERENCE TO RELATED APPLICATIONS

This application claims the benefit of co-pending U.S. patent application Ser. No. 11/135,262 filed May 23, 2005, which claims the benefit of Provisional Patent App. 60/573,098 filed May 20, 2004.

### FIELD OF INVENTION

This invention relates to fraud and theft deterrents in the retail sector. This invention relates specifically to a system for attaching security devices to sold merchandise in order to reduce incidents of fraudulent return of retail goods and refunds therefore.

### BACKGROUND

Retail theft is a problem that affects all consumers. The cost of consumer goods necessarily must be continuously increased to offset the losses to retailers that occur due to such fraud and theft. It is a recognized problem in the retail industry that various invisible forms of larceny cost the retail industry billions of dollars in lost revenue and profits every year. These invisible forms of larceny are undetectable by security cameras, security devices, store detectives or store employees. Invisible forms of larceny can occur in a variety of ways and can be committed by customers, employees, or both acting in concert. An individual typically can obtain fraudulent cash refunds, store credits, or both via return transactions of fraudulent or invalid purchases. Such fraudulent return transactions occur particularly through price tag alteration, stolen merchandise, and previously-worn garments. The customer knows the return is invalid and intends to provide a fraudulent proof of purchase receipt, or no receipt at all. Retail outlets that accept returned merchandise from customers without a proof of purchase receipt are vulnerable to lose revenue for inventory returned that was never purchased from their retail location or retail chain. In fact, this activity has become more prevalent (largely in effect throughout the holiday shopping seasons) since there is no means for retailers to ascertain the location of purchase, type or purchase, or date of purchase. Additionally, the authenticity of a retailer's physical inventory is compromised through such activity.

When a customer returns an item to a retail outlet, it is currently nearly impossible for the retailer to ascertain whether the item was truly purchased from that retail outlet. In fact, it is nearly impossible to tell for sure whether the returned item is genuine, counterfeit or a knockoff. Countless varieties of fraudulent return transactions occur daily resulting in devaluation of the inventory at the retailer as well as degradation of the consumer's opinion of the quality of goods to be purchased.

Garments and garment accessories are highly susceptible to these invisible forms of larceny, especially given the current trends of designer clothing deliberately made to appear as though it has been pre-washed, pre-worn, old, aged or matured. A typical scenario involves a person who purchases a designer garment from a major department store for $100.00. The person then goes to a discount department store, outlet mall or Internet and purchases a similar designer garment for $20.00. The person then switches the major department store retail price tag from the $100.00 garment to the $20.00 garment and then returns the lower value ($20.00) garment to the major department store for a cash refund. This same person could also purchase that same $100.00 garment, switch the retail price tag onto something old or used from their private inventory at home and then return the garment back to the major department store and receive a cash refund. Alternatively, a person could purchase a garment marked with a tag indicating it cannot be returned. The person then changes the price tag with a much higher price tag and then returns the garment either to the original retail outlet of purchase or returns the item to another retail outlet and receives a cash refund or credit.

A person could likewise purchase an expensive garment from a retail outlet, wear it out on the town, wash or dry-clean it, and then return the garment back to the retail outlet and receive a cash refund. A person could also purchase an authentic product from a retail outlet, change the retail price tags onto counterfeit goods, return the counterfeit goods and receive a cash refund. The retailer's inventory now contains counterfeit goods, and subsequent purchasers that become aware of this situation will be very dissatisfied at that retailer. Not only is the retailer's inventory devalued, furthermore, a dissatisfied consumer's experience of this problem and word of mouth to other consumers could likely lead to the retailer's loss of business in the long term.

The state of the art includes security methods that involve attaching a device directly to a garment. The most prevalent devices are removable magnetic tags or strips which alert store personnel when passed through a detector. Non-removable tags may include a hologram to show authenticity or identify a garment. These methods do not protect against fraudulent returns and refunds. A method of tagging garments with a device that protects against fraudulent returns is desirable.

Therefore, it is an object of this invention to provide a method to deter and prevent fraudulent returns of retail garments in order to obtain a refund. It is a further object that the method discourage a customer from wearing or washing a garment before returning it. Another object of this invention is to prevent a customer from returning a garment beyond the time allowed in the store's return policy.

### SUMMARY OF THE INVENTION

A method for preventing retail return fraud is implemented by attaching a security device to a customer's purchased item at checkout or before the customer leaves the store. In the preferred embodiment, during checkout the security device is stamped by a stamping machine with a code designating the retail store and time and date of purchase, and may optionally be stamped with additional identifying information such as the sale price. The security device displays human-readable text stating that the merchandise cannot be returned to the retail store if the security tag is removed, washed, or dry-cleaned. The security device may also be printed with computer-readable information. The security device may be printed with wash-intolerant ink. The security device is attached by a tamper-proof attachment mechanism, such as a loop tie. The security device is large and conspicuous. When the item is a garment, the security device is attached in a location on the garment that will discourage the customer from wearing it after purchase without removing the security device. If the customer attempts to return the item to the seller and the security device has been altered, the seller refuses to accept return.

### BRIEF DESCRIPTION OF THE DRAWINGS

FIG. 1 is a flow diagram of the preferred embodiment of the present method.

FIG. 2 is a front view of the security device used in the invention.

FIG. 3 is a rear view of the security device used in the invention.

FIG. 4 is a side view of a pair of pants with the security device attached.

FIG. 5 illustrates a security device being inserted into a stamping machine.

### DETAILED DESCRIPTION OF THE INVENTION

Once a customer has selected an item for purchase and brought it to a cash register, the retail “checkout” procedure begins. A store cashier adds the item to the customer's bill, typically by scanning a barcode or entering the item number into the cash register. “Checkout” ends when the customer collects her purchases and leaves the store.

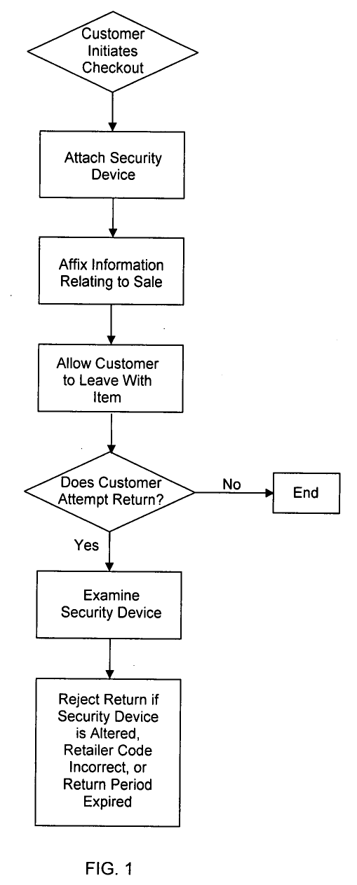

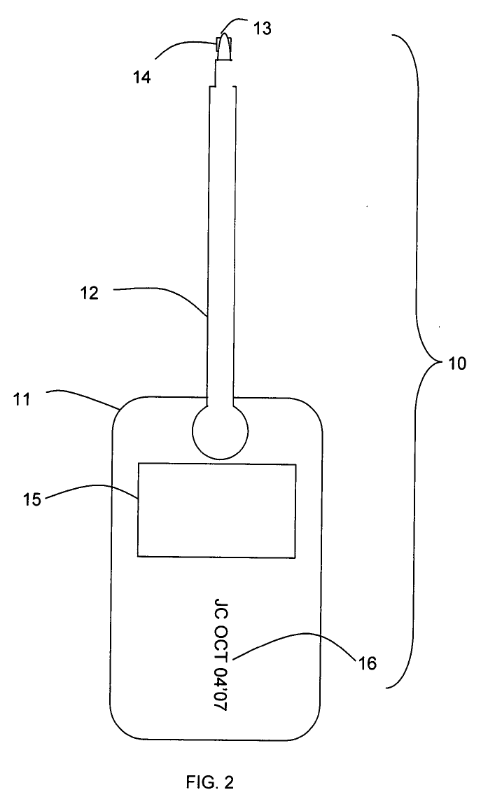

FIG. 1 illustrates the inventive method. To protect the store against return fraud, the cashier, another employee, or a third party performing security functions (collectively referred to herein as “the worker”), attaches a security device, such as the security device 10 disclosed in FIG. 2, to the item. The security device can be attached at the cash register or at some other location before the customer leaves the store. Preferably, the worker attaches the security device at the register during checkout. Alternatively, the security device may be attached once the item has arrived at the store, such as during offloading or stocking of merchandise.

The worker prints a retailer code onto the security device before or after, but preferably before, attaching the security device to the item. The retailer code contains information related to the purchase of the item, as explained below, so it must be printed on the security device after the customer has decided to buy the item. In the preferred embodiment, the worker prints the retailer code on the security device during checkout.

If the customer chooses to keep the item, the security device may be removed without damaging the item. If the customer attempts to return the item, a store employee checks to see that the security device is still attached and unwashed, and that the store's return policy has not expired as to that item. The store employee can accept the item for return if the security device is intact and the return policy is still in effect. If either condition is not satisfied, the store employee refuses to accept the garment for return.

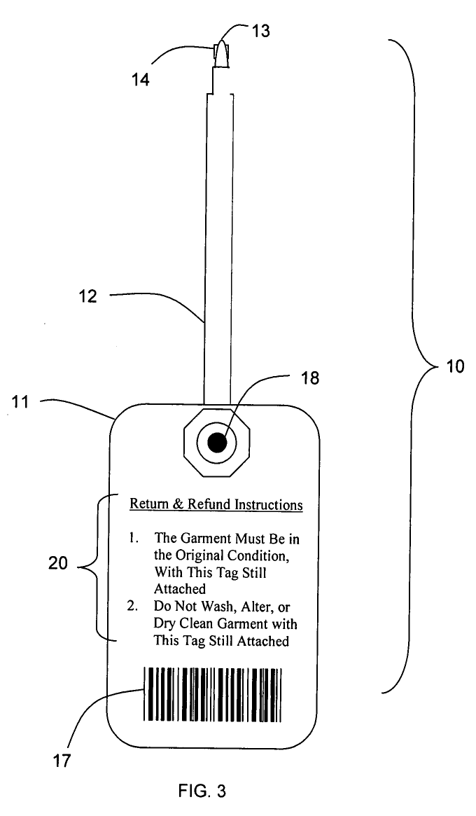

While it will be known in the art that the present invention might be used on any item offered for sale in a store, the following description specifically addresses the effective use of the invention on garments. Referring to FIGS. 2 and 3, there is illustrated the preferred embodiment of the security device 10 used in the disclosed method. A tag 11 is attached to a fastener 12 to be attached to a garment or other item. Alternatively, the tag 11 and fastener 12 are integral. On the front side of the tag 11, a retailer code 16 is printed on the tag 11 when a worker associates the tag 11 with a customer's purchased garment. The retailer code 16 is generated by an identification coding system utilized by the store. The identification coding system associates alphanumerical combinations with pieces of data that are relevant to authenticating the customer's purchase when the customer attempts to return the garment. In the preferred embodiment, the retailer code contains the following characters: the first two characters are letters that uniquely identify the retail outlet, e.g. “JC” for JCPenney®. The remaining characters represent the date of purchase in MMM DD'YY format: for example, OCT 04'07. In other embodiments, a retail outlet with multiple stores may add additional characters to represent store numbers or other identifiers. In another embodiment, a store identifier is not required and the retailer code contains only the date of purchase. In another embodiment, the retailer code also includes characters representing the price paid for the item, to protect the store against fraudulent receipts. Additional embodiments add characters to identify further details about the purchase, such as whether the item is eligible for a refund or was purchased in a final sale or on store credit.

Other information that adds functionality to the security device 10 may be printed on the tag 11. For example, a trademark 15 identifies the manufacturer of the security device 10. A barcode 17 can also be printed on the tag 11. The barcode 17 can be used for different inventory tracking schemes. For example, a store's complete inventory of security devices 10 might be printed with the same barcode 17, and the barcode 17 scanned by the cashier and the store employee taking the return, in order to keep track of how many security devices 10 leave the store and how many return. In another example, different barcodes 17 might be assigned to certain types of garments (i.e. pants, shoes) or certain brand names. In another example, the barcode 17 may serve as a stock keeping unit (SKU) number or other item number.

Referring to FIG. 3, return instructions 20 are printed on the rear side of the tag 11 to warn the customer that the garment cannot be returned once the security device 10 has been detached, washed, or dry cleaned, or if the garment has been altered.

The security device 10 may comprise multiple protective measures. One or more of the tag 11 and the ink used to print the trademark 15, the barcode 17, or the return instructions 20 may comprise ingredients that react with water or dry cleaning chemicals so that a store employee can confirm that the security device 10, and therefore the garment, was washed or dry cleaned after it left the store. In one embodiment, the tag 11 may be composed of a material that dissolves, warps, loses or changes color, or suffers other physical effects when exposed to water or dry cleaning chemicals. In the preferred embodiment, the return instructions 20 are printed with washable ink that washes completely away or becomes illegible when exposed to water or dry cleaning chemicals. In another embodiment, a watermark is printed on the security device 10 using invisible ultraviolet ink which also washes away or becomes illegible when exposed to water or dry cleaning chemicals.

To ensure that the security device 10 cannot be reattached to the garment once it is removed, the fastener 12 is a self-locking apparatus that can only be locked once. To attach the security device 10 to the garment, the fastener 12 is inserted through an aperture on the garment and threaded back out through another aperture, then locked into place. The best example of a self-locking apparatus, used in the preferred embodiment, is a self-locking nylon loop tie. Such a loop tie comprises a fastening node 13 and tabs 14 that are inserted into the lock 18. Once locked, if the node 13 is pulled out of the lock 18, the tabs 14 break off and cannot be reattached. If the tabs 14 have broken off, the fastener 12 cannot lock and the security device 10 is deemed removed from the garment.

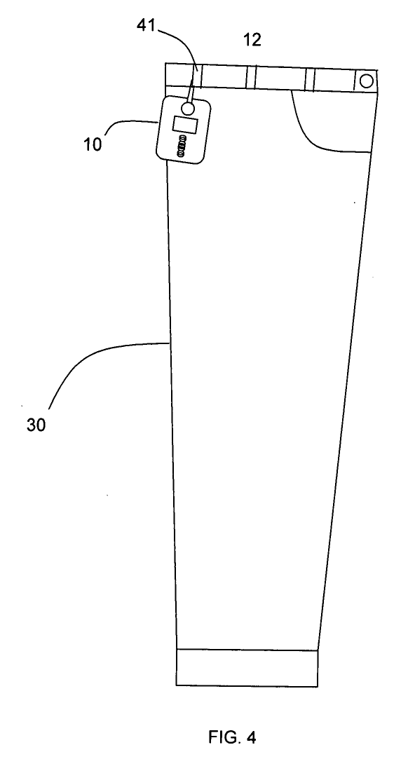

Referring to FIG. 4, there is illustrated an example of a garment, namely a pair of pants 30, with the security device 10 attached. Here, the apertures through which the fastener 12 is inserted and threaded out are the two sides of a belt loop 31. The security device 10 hangs in a conspicuous place and is preferably large and garishly colored so that the customer is not comfortable wearing the garment while the security device 10 is still attached. In other embodiments, the location of attachment of the security device 10 will depend on the type of garment: for example, on a shirt or blouse with buttons, the fastener 12 may be inserted through a buttonhole; on a shirt without buttons, the fastener may be inserted through the space between the fabric and the garment manufacturer's tag or through the loop created by the manufacturer's tag itself; on a shoe or hat, the fastener may be inserted through an eyelet. It should be understood that the security device 10 must be attached in a location where it cannot be removed without damaging it or the garment, but the attaching itself should not damage the garment and the security device 10 must be removable without damaging the garment.

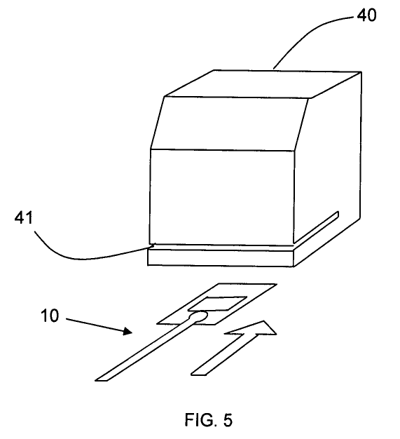

FIG. 5 illustrates the preferred embodiment of printing the retailer code 16 on the security device 10. The cashier or other store employee inserts the security device 10 into a stamping machine 40, which prints the retailer code 16 onto the tag 11. In an alternate embodiment, the retailer code 16 can be printed elsewhere on the security device 10. The stamping machine 40 can be any stamping machine presently known or later discovered which can accept and print on the material of which the security device 10 is comprised. In the preferred embodiment, for example, the tag 11 is made of paper with a density and flexibility similar to a credit card or driver's license, and the stamping machine 40 accepts the tag 11 in an insertion slot 41 and stamps the retailer code 16 onto the tag 11 in ink. In an alternate embodiment, the stamping machine imprints the retailer code 16 into the tag 11 without the need for ink. The stamping machine 40 is programmable by human or computer, and has an internal calendar that updates daily so the correct date is printed in the retailer code 16.

In the preferred embodiment, the stamping machine 40 is located at the checkout counter, near the register the customer has approached, so that the cashier can print the retailer code 16 on the security device 10 and attach it to the garment. In an alternate embodiment, the stamping machine is integrated into the store's electronic data management system by being electronically connected to the register. The connection supports communication between the register and the stamping machine 40, so that the register is informed when a security device 10 has been stamped, or so the stamping machine 40 knows the correct purchase price or other data to be printed in the retailer code 16, as is done in alternate embodiments.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. A method for protecting a seller against fraudulent return of an item sold to a customer, the method comprising:
a) attaching a security device to the item, wherein the security device is removable from the item only by altering the security device or damaging the item;
b) affixing information relating to the sale of the item to the security device; and
c) when the customer attempts to return the item to the seller, refusing to accept return if the security device has been altered.

2. The method according to claim 1 wherein the item is a garment.

3. The method according to claim 1 wherein affixing information relating to the sale of the item comprises printing information relating to the sale of the item.

4. The method according to claim 3 wherein printing information relating to the sale of the item comprises inserting the device into a stamping machine configured to print information relating to the sale of the item.

5. The method according to claim 1 wherein information relating to the sale of the item comprises a retailer code comprising a retailer identifier and the date the item was sold to the customer.

6. The method according to claim 1 wherein altering the security device comprises detaching the security device from the item.

7. The method according to claim 1 wherein altering the security device comprises exposing the security device to a substance that causes a change in the security device.

8. The method according to claim 7 wherein the change is a visually detectable change in the appearance of the security tag.

9. The method according to claim 2 wherein the security device is attached in a location on the garment that discourages the customer from wearing the garment after purchase with the security device attached.

10. The method according to claim 9 wherein the location on the garment is through a belt loop.

11. The method according to claim 9 wherein the location on the garment is through a button hole.

12. The method according to claim 9 wherein the location on the garment is through a shoelace hole.

13. The method according to claim 1 wherein the security device comprises a tag and an attachment mechanism connected to the tag.

14. The method according to claim 13 wherein the attachment mechanism comprises a self-locking loop tie.

15. The method according to claim 13 wherein the tag comprises a barcode printed on a front side and a set of return instructions printed on a rear side.

16. The method according to claim 4 wherein the stamping machine is electrically connected to a cash register and capable of reciprocal transmission of data between it and the cash register.

17. The method according to claim 1 wherein the security device is attached to the item prior to sale.

18. The method according to claim 1 wherein the security device is attached to the item at substantially the same time as the item is sold.

19. The method according to claim 1 wherein the security device is attached to the item after the item is sold.

20. A method for protecting a seller against fraudulent return to the seller's store of a garment sold to a customer, the method comprising:
a) attaching a tamper-proof security device to the garment after sale but before the customer leaves the seller's store, the security device comprising:
i. a tag;
ii. a barcode printed on the tag;
iii. a set of return instructions printed on the tag warning the customer that the garment cannot be returned if the security device is removed or the garment is washed or dry cleaned; and
iv. a self-locking loop tie attached to the tag;
b) inserting the security device into a stamping machine, located near a register where the customer begins checkout, that stamps a retail code on the security device in ink, the retail code comprising a plurality of alphanumeric characters that identify the seller and the date the garment was purchased; and
c) when the customer attempts to return the garment to the seller, refusing to accept return if the security device has been modified, exposed to water or dry cleaning chemicals, or removed;
wherein the security device is attached to the garment in a location that discourages the customer from wearing the garment while the security device is attached.
